(19) United States
(12) Patent Application Publication
(10) Pub. No.: US 2014/0058859 A1
(43) Pub. Date: Feb. 27, 2014

(54) Point of Sale Multi-Functional Devices

(71) Applicant: Lael Andrew ALEXANDER, Houston, TX (US)

(72) Inventor: Lael Andrew ALEXANDER, Houston, TX (US)

(21) Appl. No.: 13/972,208

(22) Filed: Aug. 21, 2013

Related U.S. Application Data
(60) Provisional application No. 61/691,479, filed on Aug. 21, 2012.

(51) Int. Cl. G06Q 20/20

(52) U.S. Cl. CPC G06Q 20/20
USPC 705/17; 705/16; 705/25

(57) ABSTRACT

Improvements in a point of sale multi-functional device are disclosed. The device can operate as a stand-along unit or as a tablet companion device. The features include but are not limited to readers of credit cards, bar codes, flatbed scanner. Connections for USB, HDMI, SIM cards, flash memory and earphones or external speakers. A power supply provides power to the device with sufficient capacity to operate as long as required for sales transactions. The unit utilizes an embedded wireless connection with WiFi, 3G, and 4G using cell phone type communication signal or equivalent to allow the device to communicate with the internet to complete the transaction without requiring the device to store any information locally. The tablet compatible device accepts a tablet where the tablet thereby provides the display, computational power, wireless connection to the internet or a network and control of the sales process.

### CROSS REFERENCE TO RELATED APPLICATIONS

This application claims the benefit of Provisional Application Ser. No. 61/691,479 filed Aug. 21, 2013 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a tablet companion connection device. More particularly, the present tablet multi-functional companion device that allows a tablet to physically integrate with a companion product to provide features such as a card reader, scanner, printer and barcode readers.

2. Description of Related Art Including Information Disclosed Under 37 CFR 1.97 and 1.98.

Tablet devices have become more sophisticated by providing connectivity to the internet wherever they can obtain a signal. Along with the development of tablets there has been an increasing need to provide non-cash transactions and business at locations that don't have power. The retail needs at these locations are essentially the same as at a brick and mortar building location. The need to provide retail sales transactions requires a product that provides the needed features in a single integrated or integrateable unit.

A number of patents and or publications have been made to address these issues. Exemplary examples of patents and or publication that try to address this/these problem(s) are identified and discussed below.

U.S. Pat. No. 5,484,991 issued on Jan. 16, 1996 to Richard A. Sherman et al., discloses a Portable Modular Work Station Including Printer and Portable Data Collection Terminal. The device disclosed in this patent is for the collection of data. Connections for printers and other devices are with cabling. The modular nature provides a base structure where these devices can be connected and carried as a single unit. Because this device collects data any collected data can only be transferred to an internet connection when the device is connected to a wired internet connection. This patent does not disclose using a tablet or portable device with wireless connection. It further does not provide a single integrated self-contained solution.

U.S. patent application publication U.S. 2004/0111320 was published on Jun 10, 2004 for Jorg Schlieffers et al., discloses an Electronic Shopping System. This disclosure in this publication is for a tablet type device that in integrated with a grocery store type shopping cart. A customer brings their own mobile companion device then connects with the tablet-shopping cart and the user is directed to the location of items or products within the store. The user can scan the items as they are placed in the shopping cart.

U.S. patent application publication U.S. 2006/0180659 was published on Aug. 17, 2006 for Cathy A. Loffredo et al discloses a Patient Information Management System. This device is used in a hospital or other location where patient care is being provided. The device uses the hospital database to identify patient information and care that was given and needs to be given. While this device provides wireless communication to the device it does not provide point of sale information or scanning capability.

What is needed is a portable point of sale device or a tablet compatible device that provides a complete retail terminal where wired internet connection is not available nor is an external power source. The proposed device provides a solution with a self-contained point of sale device as a single device or as a tablet embeddable companion device.

### BRIEF SUMMARY OF THE INVENTION

It is an object of the point of sale multi-functional device to include the features that are needed to complete retail sales transactions. These features include but are not limited to readers of credit cards, bar codes, flatbed scanner. Connections for USB, HDMI, SIM cards, flash memory and earphones or external speakers. A power supply provides power to the device with sufficient capacity to operate as long as required for sales transactions. The power supply can also be recharged or replaceable to further extend the period of time the device can be used.

It is an object of the point of sale multi-functional device to provide wireless connection with WiFi, 3G, 4G using cell phone type communication signal or equivalent to allow the device to communicate with the internet to complete the transaction without requiring the device to store any information locally.

It is another object of the point of sale multi-functional device to operate as a tablet compatible device where the tablet is embedded or otherwise joined with the device. The tablet thereby provides the display, computational power, wireless connection to the internet or a network and control of the sales process. The device provides a power supply for the tablet, the printer, the scanner, and any readers such as bar code reading equipment.

It is still another object of the point of sale multi-functional device to be a self-contained point of sale device that can be transported as a single unit and operated to make sales transactions with providing a receipt and a signature input device. This unit provides a complete device that can be easily transported and utilized without requiring a wired connection or external power supply for operation.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of a tablet multi-functional companion device.

FIG. 2 shows a perspective view of the multi-functional companion device with a tablet device being inserted.

FIG. 3 is a back view of the tablet multi-functional companion device.

FIG. 4 is a side view of the tablet multi-functional companion device.

FIG. 5 is a top view of the tablet multi-functional companion device.

FIG. 6 is a perspective view of the mobile point of sales device.

FIG. 7 is a side view of the mobile point of sales device.

FIG. 8 is a back view of the mobile point of sales device.

FIG. 9 is an exploded back view of the mobile point of sales device.

FIG. 10 is a front perspective view a second embodiment of the mobile point of sales device.

FIG. 11 is a back perspective view of the second embodiment of the mobile point of sales device.

### DETAILED DESCRIPTION OF THE INVENTION

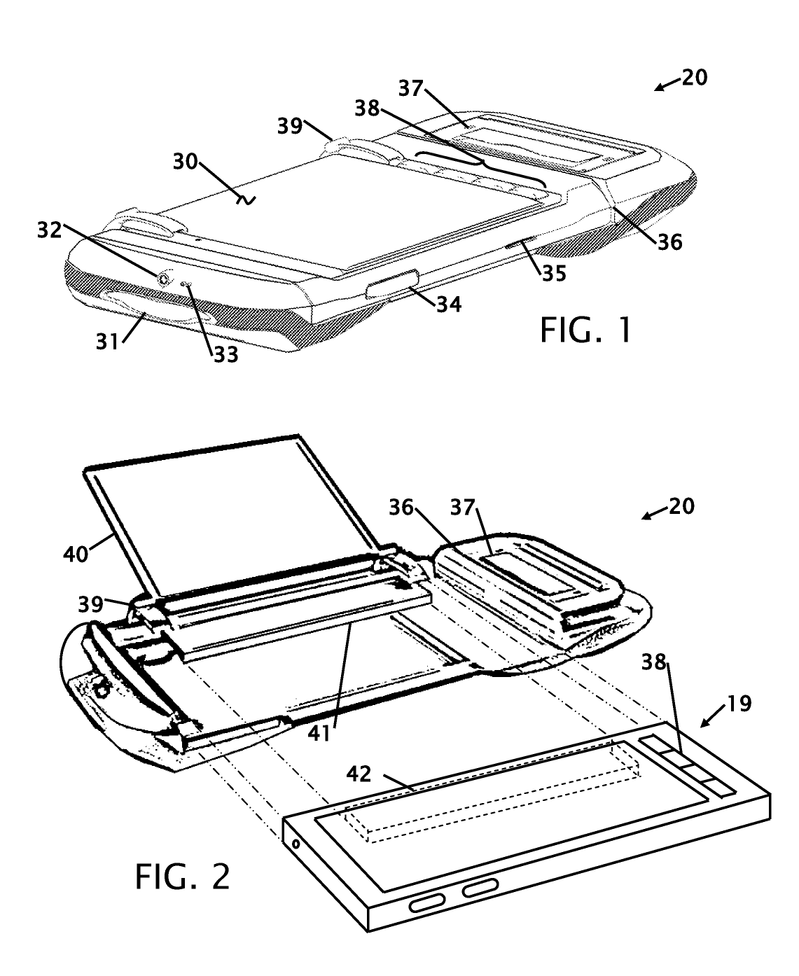

FIG. 1 shows a perspective view of a tablet multi-functional companion device 20. The companion device is configured for a tablet to be nested within the device. The device provides additional features that are not found on tablets. The tablet provides the computational power and internet connection. Each tablet has a unique identification that whereby a single companion device can be used with multiple tablets were each user brings their own tablet and connects their unique tablet into a single companion device 20.

The companion device has a front cover 30 or lid that with an internal scanner for scanning or copying information placed on or within the scanner lid 30. One end or side of the companion device includes a bar code scanner 31, remote control functions for IR 32, ultrasonic and or FM communications 33. Other features can include but are not limited to blood alert, DNA, flash drive reader, QR code, signature capturing, microphone, camera, car fob functions and phone jack. A power button 34 turns the device on and off, and can also control sleep or hibernation functions. A slot 35 allows for a charging port using common charging cords.

The top of the housing further includes a card swipe reader 36 that can read credit cards, driver's license and other cards or items with magnetically encoded data. A printer 37 allows for printing of receipts, images that were scanned or other information where a hard printed copy or receipt is required. The top of the housing provides commonly used control keys 38. In the preferred embodiment these keys are identified as home, information, enter and zoom. While these buttons and functions are shown as fixed mechanical type buttons they can also be soft keys with changeable and customizable features and or functions. Two guides or tracks allows the lid 30 to hinge open and or swing over and around the device to give access to the internal cavity where the tablet is placed and stored as shown in FIG. 2.

FIG. 2 shows a perspective view of the multi-functional companion device 20 with a tablet device 19 being inserted. To insert a tablet 19, the battery and or a connection terminal 42 within the tablet is opened and or removed. The companion device 20 is opened to expose the connection and or battery 41 within the companion device 20. The tablet 19 is then inserted or otherwise connected to the companion device 20 and the lid 40 is closed thereby linking the two devices together. The lid 40 pivots and or swings over and around the companion device on guides 39 to at least partially cover the tablet 19. One or more of the buttons or keys 38 from the tablet can be accessed while the tablet 19 is installed within the companion device. The magnetic card reader 36 and the printer 37 are shown with companion device 20.

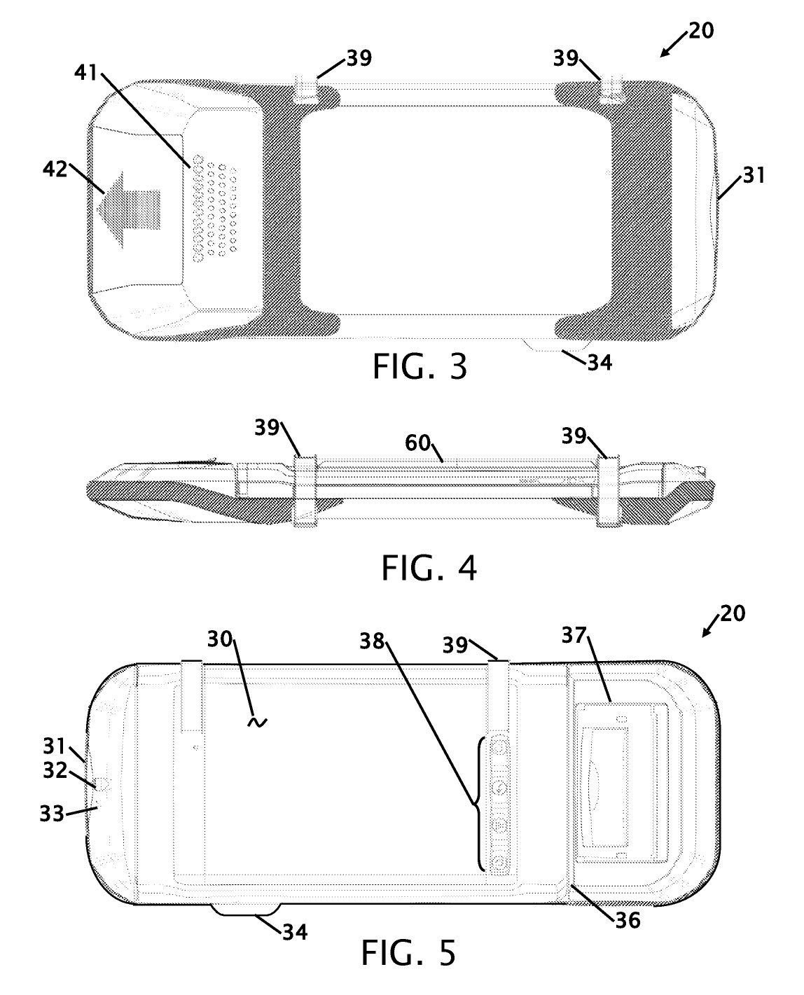

FIG. 3 is a back view of the tablet multi-functional companion device 20, FIG. 4 is a side view of the tablet multi-functional companion device 20 and FIG. 5 is a top view of the tablet multi-functional companion device 20. In these views the preferred industrial design of the companion device with an installed tablet is shown. While this particular design is shown and described, one skilled in the art can appreciate that other design feature orientations and configurations can be made. In the back view shown in FIG. 3 holes 41 provide openings for sound are visible. The sounds can come from the companion device or from the tablet. An access door 42 provides and opening for insertion of paper within the printer 37 that is visible in the top view in FIG. 5.

In FIG. 5 the lid or cover 30 is shown with the buttons 38 from the tablet showing on the sides of the companion device. The cover 30 swings, flips, rotates or otherwise moves upon guides 39 from the front to the back of the companion device. Moving the cover 30 from the front to the back of the device provides unrestricted view of the screen on the inserted tablet 19. One end or side of the companion device includes a bar code scanner 31, remote control functions for IR 32, ultrasonic and or FM communications 33. Other features can include but are not limited to blood alert, DNA, flash drive reader, microphone, QR code camera, car fob functions and phone jack. A power button 34 turns the device on and off, and can also control sleep or hibernation functions. The top of the housing further includes a card swipe reader 36 that can read credit cards, driver's license and other cards or items with magnetically encoded data.

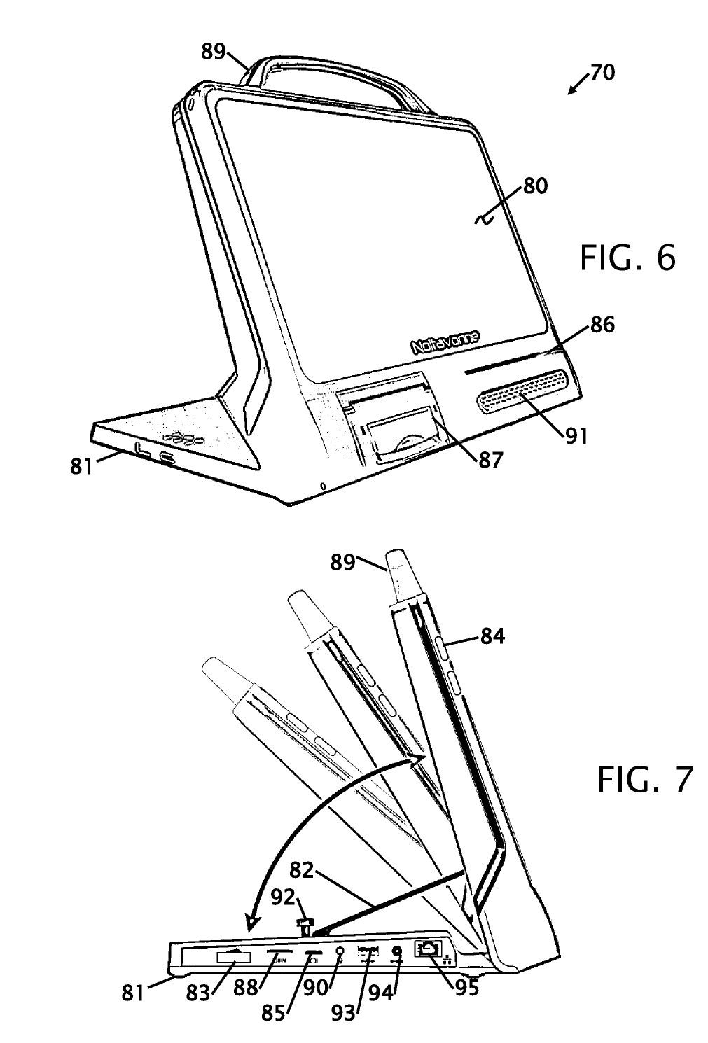

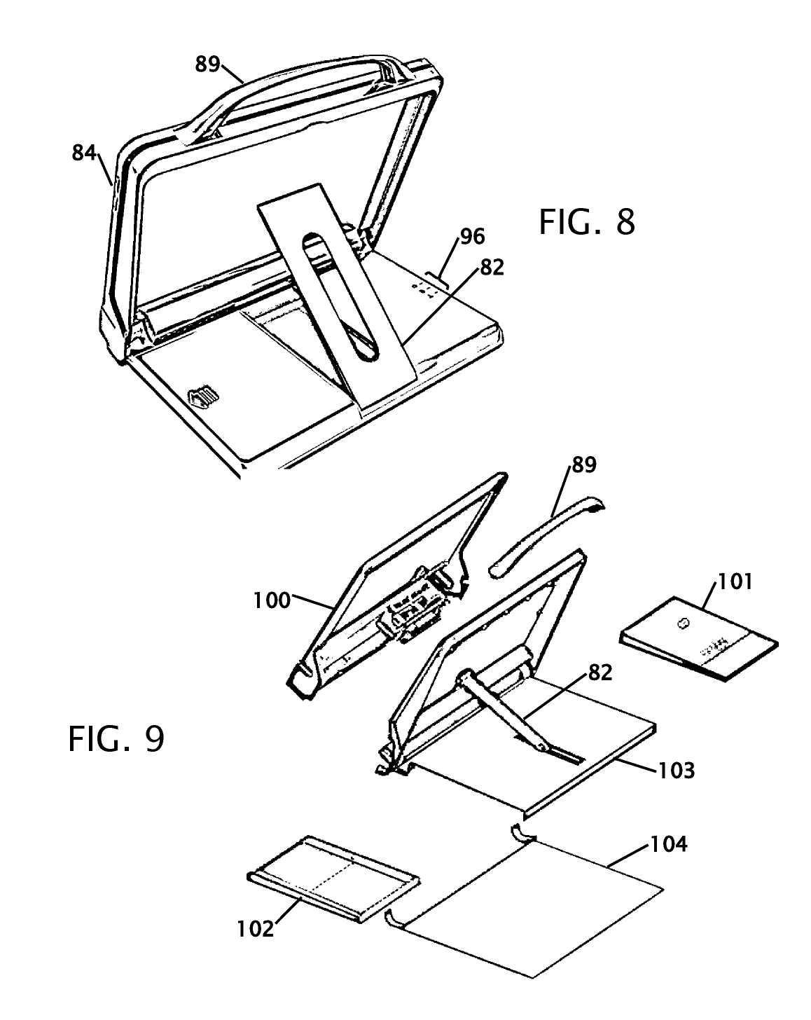

FIG. 6 is a perspective view of the mobile point of sales (POS) device 70 and FIG. 7 is a side view of the mobile point of sale (POS) device 70. This device is a self-contained POS unit 70. The POS unit 70 can fold fairly flat as shown in FIG. 7 or can be rotated from the base 81 to a desired angle. The front of the POS unit 70 has a display screen 80 with a magnetic strip reader (MSR) slot 86 for reading credit cards or other types of cards with an encoded magnetic data strip. A speaker 91 provides audible feedback. The front of the POS unit 70 also includes a printer 87 for printing a receipt or other record. A handle 89 located on the unit allows for easy transportation of the POS unit 70. The side view in FIG. 7 shows connection and communication ports.

From this side view, this base unit includes connection and communication ports for a USB connector 93 to allow for physical connection or USB devices. A SIM card port 88 allows for connection of a flash or similar drive to be connected for data transfer. A connection for an external monitor 85 HDMI is also provided along with a connection for headphones 90. A power connection 94 provides power to the unit and also charges an internal battery to allow for use where external power is not available. An Ethernet connector 95 is used to connect with a wired network. A connection for a TF card 83 is also contemplated. Speaker volume control button(s) 84 are located on the side of the display portion of the housing. Various types of support member(s) 82 are contemplated to control the angle of the screen. Depending upon the environment and the height of the user the angle between the base 81 and the display portion can be adjusted using support 82 and stop or locking mechanism 92.

The support member 82 connects from the base unit to the back of the display unit. FIG. 8 is a back view of the mobile point of sales device and FIG. 9 is an exploded back view of the mobile point of sales device. The top of the base unit has a series of indicator lights 96 that provide the user with information on power, battery, WiFi, network link, and other status information. The volume button(s) 84 and the handle 89 are shown in these figure(s). The exploded view of FIG. 9 shows the front display housing 100 along with the base housing 103 having an adjustable support 82. The base housing 103 has a bottom housing 104. Modules 101 and 102 are made with a variety of features and function that can be swapped or upgraded based upon the needs of the end user. These modules include but are not limited to batteries, I/O. connections, drives, memory and communication ports.

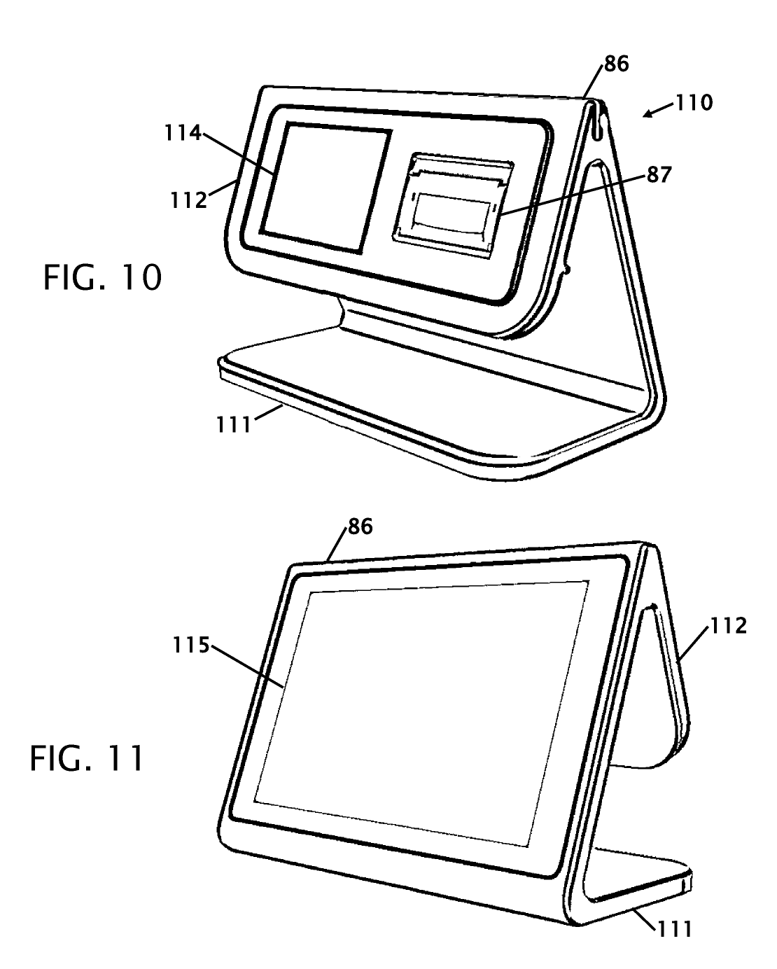

FIG. 10 is a front perspective view a second embodiment of the mobile point of sales device and FIG. 11 is a back perspective view of the second embodiment of the mobile point of sales device. This is a double sided POS unit 110 that provides information to both the sales person and the buyer. One side of the unit shown in FIG. 10 provides a small display 114 with a printer 87. A MSR card reader 86 is located at the top of the unit to provide access to both the sales persona and the buyer. The opposing side of the unit is visible in FIG. 11 with a larger display 115. A single base 111 provides a support stand to the unit. In the preferred embodiment the display screen(s) 114 and 115 are touch screen thereby enabling a user to touch the screen to enter a password, or signature. It is also contemplated that the POS unit 110 has communication with a barcode scanner of other product identifier.

Thus, specific embodiments of a point of sale multi-functional device have been disclosed. It should be apparent, however, to those skilled in the art that many more modifications besides those described are possible without departing from the inventive concepts herein. The inventive subject matter, therefore, is not to be restricted except in the spirit of the appended claims.

1. A point of sale multi-functional device comprising:
a housing;
said housing providing a cavity for physical connection with a personal communication device within said housing;
said housing further including at least one of a group consisting of a printer, a scanner, a power supply, a credit card reader, a display, and
said personal communication device provides internet communication that utilizes features connected to said housing.

2. The point of sale multi-functional device according to claim 1 wherein said personal communication device is a tablet computer.

3. The point of sale multi-functional device according to claim 1 wherein said personal communication device is a cellular phone.

4. The point of sale multi-functional device according to claim 1 wherein said personal communication device communicates said internet with a WiFi, Bluetooth, cellular network, GSM, CDMA, G3 or G4 connection.

5. The point of sale multi-functional device according to claim 1 wherein said personal communication device communicates to said housing through Bluetooth, wired or wireless connection.

6. The point of sale multi-functional device according to claim 1 wherein said housing further includes a power supply that provides power for said housing and or said personal communication device.

7. The point of sale multi-functional device according to claim 1 wherein said housing further includes a SIM card slot.

8. The point of sale multi-functional device according to claim 1 wherein said housing further includes at least one USB output port.

9. The point of sale multi-functional device according to claim 1 wherein said housing provides a connection for an external monitor.

10. The point of sale multi-functional device according to claim 1 wherein said housing is operable in a flat orientation or at a desired angle.

11. The point of sale multi-functional device according to claim 1 wherein said personal communication device provides computing power to said housing functions.

12. The point of sale multi-functional device according to claim 1 wherein said point of sale multi-functional device provides point of sale functions to complete a cash or non-cash sales transaction.

13. The point of sale multi-functional device according to claim 1 wherein said housing further includes a barcode scanner.

14. The point of sale multi-functional device according to claim 1 wherein said housing further includes a signature capturing device or surface.

15. The point of sale multi-functional device according to claim 1 wherein said card reader reads credit cards, divers license and magnetically encoded data.

16. The point of sale multi-functional device according to claim 1 wherein said housing further includes commonly used control keys from a group consisting of at least one of a home, an information, an enter, and a zoom.

17. The point of sale multi-functional device according to claim 16 wherein said commonly used control keys are changeable and customizable features and or functions.

18. The point of sale multi-functional device according to claim 1 wherein said housing includes guide rails and or tracks to guide and locate said personal communications device within said housing.

19. The point of sale multi-functional device according to claim 1 wherein said housing further includes a cover that swings, flips or rotates from a front to a back of said housing.

20. The point of sale multi-functional device according to claim 1 wherein said housing with said personal communications device provides a display on opposing side of said point of sale multi-functional device.
